(19) United States
(12) Patent Application Publication
(10) Pub. No.: US 2016/0324134 A1
(43) Pub. Date: Nov. 10, 2016

(54) Fishing Rod Jigging Device

(71) Applicant: Kent Pikarski, Wahpeton, ND (US)

(72) Inventor: Kent Pikarski, Wahpeton, ND (US)

(21) Appl. No.: 15/138,310

(22) Filed: Apr. 26, 2016

Related U.S. Application Data
(60) Provisional application No. 62/158,896, filed on May 8, 2015.

(51) Int. Cl. A01K 91/06; A01K 87/00

(52) U.S. Cl. CPC A01K 91/065; A01K 87/00

(57) ABSTRACT

A fishing rod jigging device for automatically moving a fishing rod in an up and down motion so as to move the fishing line within the water. The jigging device includes a housing having a drive assembly, and having a support arm extending outwardly from the housing. The support arm includes a fishing rod holder on a distal end thereof in which a fishing rod can be removably supported. The drive assembly moves the support arm in an up and down reciprocating motion along a vertical axis. The drive assembly includes a cam that rotates and engages the support arm so as to change the position thereof. In this way, the entire fishing rod is moved up and down in a reciprocating motion so as to create movement of the fishing line within the water.

### CROSS REFERENCE TO RELATED APPLICATION

This application claims the benefit of U.S. Provisional Application No. 62/158,896 filed on May 8, 2015. The above identified patent application is herein incorporated by reference in its entirety to provide continuity of disclosure.

### BACKGROUND OF THE INVENTION

### Field of the Invention

The present invention relates to fishing devices. More specifically, the present invention provides a fishing rod support device adapted to move a fishing rod up and down in a bobbing or jigging motion without the involvement of the user.

While fishing, it is often useful for the fisherman to move the fishing rod so as to impart motion on the fishing line for the purpose of moving the bait in the water. Particularly, the fisherman may jig the fishing rod by moving the fishing rod upwardly and downwardly so as to move the fishing line. The motion of the bait in the water helps to draw the attention of fish in the nearby area as the fish are more likely to notice the bait. Further, the upward and downward motion of the bait helps the bait to more closely resemble a living bait, which is also attractive to fish. However, manually jigging the fishing rod can be tiresome and the fisherman may not want to bob the line repeatedly. Fishermen often place a fishing rod in a support or holder while fishing so that a fisherman does not have to constantly hold the fishing rod. However, if the fisherman wishes to bob or jig the line, then he or she must be holding the fishing rod. This prevents the fisherman from taking a break or performing any of various other tasks. Further, operating the rod by hand limits the fisherman to the use of a single fishing rod. Thus, a device for supporting a fishing rod and that also moves the fishing rod to create a bobbing or jigging motion is desired.

Devices have been disclosed in the prior art that relate to fishing rod jigging devices. These include devices that have been patented and published in patent application publications. These devices generally relate to fishing rod holding and jigging devices for causing the fishing rod to move, such as U.S. Pat. No. 6,009,656, U.S. Published Patent Application Number 2006/0248778, U.S. Pat. No. 8,919,029, U.S. Pat. No. 5,540,010, U.S. Pat. No. 7,845,106, U.S. Pat. No. 8,136,289, and U.S. Published Patent Application Number 2014/0182188.

These prior art devices have several known drawbacks. Several devices in the prior art cause a fishing rod to move in a jigging motion by pivotally rotating the fishing rod itself, which can be undesirable as this may result in movement of the bait and hook away from a desired location for fishing. Rather than providing a bobbing up and down motion of the bait, such devices may instead result in lateral movement which may be undesirable.

In light of the devices disclosed in the prior art, it is submitted that the present invention substantially diverges in design elements from the prior art and consequently it is clear that there is a need in the art for an improvement to existing fishing rod support devices. In this regard the instant invention substantially fulfills these needs.

### SUMMARY OF THE INVENTION

In view of the foregoing disadvantages inherent in the known types of fishing rod jigging devices now present in the prior art, the present invention provides a new fishing rod jigging device wherein the same can be utilized for providing convenience for the user when automatically jigging a fishing rod.

The fishing rod jigging device comprises a housing having a drive assembly adapted to impart reciprocating motion on a support arm that extends outwardly from the housing. The support arm is substantially horizontal in configuration and includes a fishing rod holder on an end thereof, wherein the fishing rod holder is adapted to removably secure a fishing rod at an upward angle. The drive assembly includes a motor that drives a cam, wherein the rotation of the cam imparts reciprocal motion to the support arm. The support arm moves vertically upward and downward along a channel on the housing such that the support arm and fishing rod held on the end thereof is moved in an up and down motion.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the fishing rod support device.

FIG. 2 shows a transparent view of the fishing rod support device.

FIG. 3 a schematic diagram of the components of the fishing rod support device.

FIG. 4 shows a side cross-sectional view of the cam of the fishing rod support device.

### DETAILED DESCRIPTION OF THE INVENTION

Reference is made herein to the attached drawings. Like reference numerals are used throughout the drawings to depict like or similar elements of the fishing rod support device. For the purposes of presenting a brief and clear description of the present invention, the preferred embodiment will be discussed as used for automatically moving a fishing rod in a bobbing or jigging motion without the involvement of the user. The figures are intended for representative purposes only and should not be considered to be limiting in any respect.

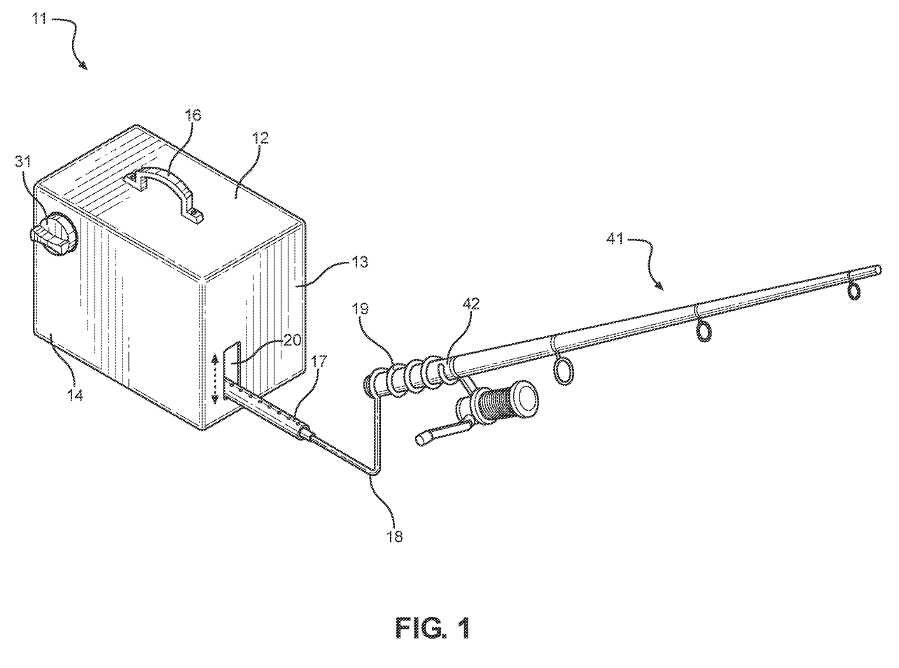

Referring now to FIG. 1, there is shown a perspective view of the fishing rod support device. The fishing rod support device 11 comprises a housing 12 that encloses a drive assembly adapted to move a support arm 17 up and down in a reciprocating motion along a vertical axis. The support arm 17 comprises an elongated rod having a substantially horizontal orientation, wherein a portion of the support arm 17 is enclosed within the housing 12, and wherein a portion of the arm 17 extends outward from a first end 13 of the housing via a channel 20 thereon. The arm 17 is adapted to move up and down along the length of the channel 20 as it is driven by the drive assembly. The drive assembly is operated via a control 31 disposed on a sidewall 14 of the housing 12, wherein the control 31 allows the user to adjust the speed of the drive assembly. The housing 12 may further include a handle 16 thereon to allow the user to more easily lift and transport the device 11.

The arm 17 is preferably adjustable in length. In the illustrated embodiment, the arm 17 comprises a telescopic configuration and includes an extension segment 18 that extends therefrom. The extension segment 18 is movably disposed within the arm 17 and can be extended therefrom or retracted into the arm 17. The extension segment 18 can be secured at the desired length via any suitable fastener. In the illustrated embodiment, the arm 17 is shown as having a pin-locking system comprising plurality of apertures through which a pin can be inserted so as to secure the extension segment 18 in a fixed position. The arm 17 can be extended in order to better position the fishing rod without having to move the housing 12 of the fishing rod jigging device 11. Further, the arm 17 may be extended for fishermen who are fishing from inside of an ice fishing shelter, such that the arm 17 extends from the interior of the ice fishing shelter to the exterior thereof so that the user can fish from inside of the ice fishing shelter. Extending the support arm 17 also allows the fisherman to effectively extend his or her reach as a fishing rod holder 19 is disposed on the distal end thereof.

In the illustrated embodiment, the fishing rod holder 19 comprises a vertical segment and a corkscrew configuration adapted to removably engage the handle 42 of a fishing rod 41. Any of various types of conventional fishing rods may be supported by the fishing rod holder 19. The vertical segment helps to dispose the handle 42 of a conventional fishing rod 41 at an elevated position above the surface on which the housing 12 rests to provide the fisherman with easier access to the fishing rod 41. The rod holder 19 is preferably positioned at an acute angle relative to a horizontal plane so as to support the fishing rod 41 in an upward or inclined angle, similar to the manner in which a fisherman would support the fishing rod 41 when fishing by hand. The rod holder 19 securely holds the fishing rod 41 such that the fisherman does not have to manually hold the rod. Further, if a fish is caught on the line, the fisherman can easily remove the fishing rod 41 from the fishing rod holder 19 in order to manually reel in the fish.

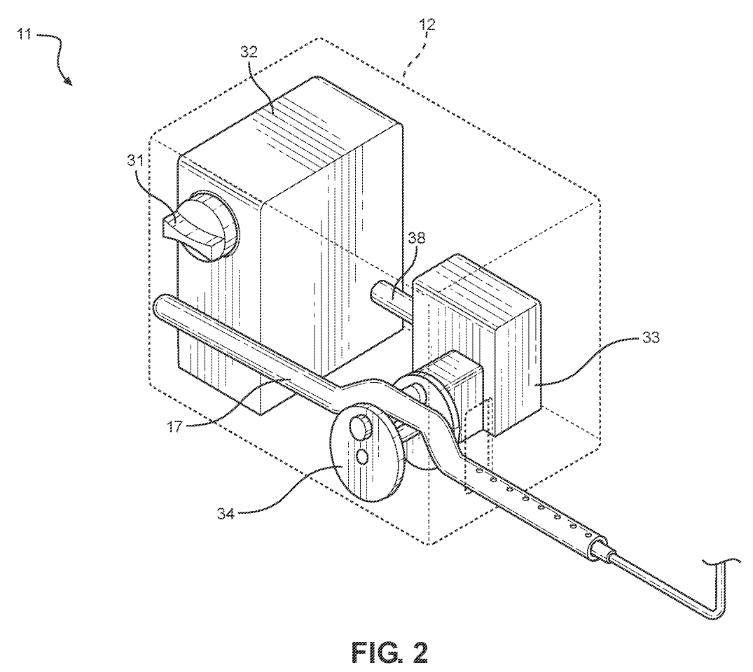

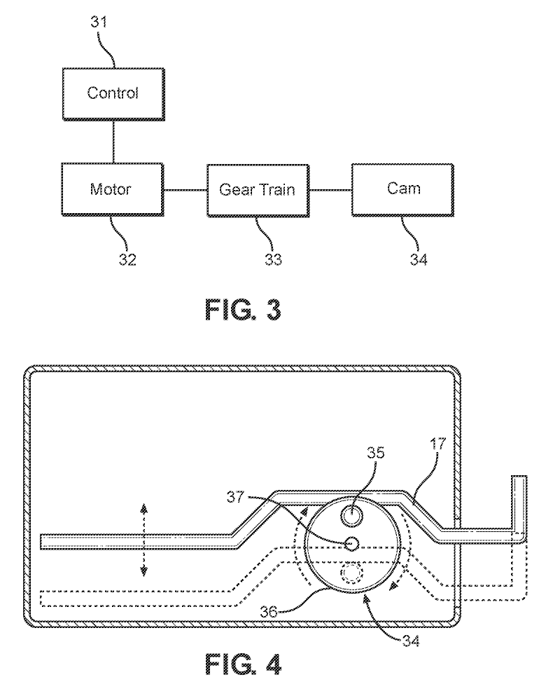

Referring now to FIGS. 2 and 3, there is shown a transparent view of the fishing rod support device and a schematic view of the components of the drive assembly, respectively. The drive assembly comprises a motor 32 having a control 31 thereon. The control 31 dictates the rotational speed or output speed of the motor 32. The motor 32 drives a gear train 33 which in turn drives a cam 34. In the illustrated embodiment, the motor 32 rotatably drives a driveshaft 38 that engages the gear train 33. The gear train 33 cause the cam 34 to rotate in a circular motion, wherein the support arm 17 is positioned above the cam 34 so as to be engaged by the cam 34. The rotation of the cam 34 causes the arm 17 to move in an up and down reciprocating motion along a vertical axis. In this way, a fishing rod secured to the support arm 17 is moved up and down so as to create a jigging motion of the line.

Referring now to FIG. 4, there is shown a side cross-sectional view of the cam of the fishing rod support device. In the illustrated embodiment, the cam 34 includes a disk 36 having a protrusion 35 extending from a peripheral portion thereof. The disk 36 is positioned in a vertical orientation and rotates about a horizontal axis extending through the center 37 of the disk 36. When the disk 36 rotates, the protrusion 35 thereon moves between a first position that is the highpoint of the position of the protrusion 35 and a second position that is the low point of the position of the protrusion 35. A portion of the arm 17 rests on top of the protrusion 35 and is contacted thereby. As the cam 34 rotates, the protrusion 35 moves in a circular motion between the first position and the second position causing the arm 17 to move in an upward and downward motion. The cam 34 can be driven in a clockwise or counterclockwise orientation depending upon the embodiment. The gear train serves to reduce the rotational output of the motor to a rotation speed of the cam 34 that is consistent with a bobbing or jerking motion. Preferably, the cam 34 is driven at such a rotational speed that the fishing rod provides an intermittent jigging motion.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A fishing rod jigging device, comprising:
a housing having a drive assembly and a support arm;
wherein the support arm includes a fishing rod holder on an end thereof;
the drive assembly comprises a motor that rotatably drives a cam, wherein the cam engages the support arm as it rotates so as to move the support arm upwardly and downwardly along a vertical axis.

2) The fishing rod jigging device of claim 1, wherein the drive assembly further comprises a gear train driven by the motor, wherein the gear train drives the cam.

3) The fishing rod jigging device of claim 1, wherein the motor drives a driveshaft that in turn drives a reducing gear assembly.

4) The fishing rod jigging device of claim 1, wherein the support arm extends from the housing in a substantially horizontal orientation.

5) The fishing rod jigging device of claim 1, wherein the support arm comprises a telescopic configuration such that the support arm is adapted to be adjusted in length.

6) The fishing rod jigging device of claim 1, wherein the fishing rod holder comprises a corkscrew configuration adapted to encircle the handle of a fishing rod.

7) The fishing rod jigging device of claim 1, further comprising a control operably connected to the motor and adapted to control the rotation output speed thereof.

8) The fishing rod jigging device of claim 1, wherein the fishing rod support is positioned at an angle relative to a horizontal plane.

9) The fishing rod jigging device of claim 1, wherein the cam comprises a circular disk having a protrusion thereon, wherein the protrusion engages the support arm as the cam rotates.

10) A fishing rod jigging device, comprising:
a housing having a drive assembly, and a support arm extending outwardly from the housing through a channel thereon;
wherein the support arm includes a fishing rod holder on an end thereof;
the drive assembly comprises a motor that rotatably drives a gear train, wherein the gear train drives a cam;
wherein the cam engages the support arm as it rotates so as to move the support arm in reciprocating motion along the channel.
